(19) United States
(12) Patent Application Publication
(10) Pub. No.: US 2021/0192414 A1
(43) Pub. Date: Jun. 24, 2021

(54) SYSTEMS AND METHODS FOR PROVIDING ASSESSMENT FRAMEWORKS

(71) Applicant: IPCO 2012 LIMITED, London (GB)

(72) Inventors: Timothy Neill, Chelmsford (GB); Thomas Dirs, Crowborough (GB)

(21) Appl. No.: 17/124,292

(22) Filed: Dec. 16, 2020

Related U.S. Application Data
(60) Provisional application No. 62/950,484, filed on Dec. 19, 2019.

(51) Int. Cl. G06Q 10/06; G06Q 30/02; G06Q 30/00; G06Q 10/10

(52) U.S. Cl. CPC G06Q 10/06393; G06Q 30/0282; G06Q 50/26; G06Q 30/018; G06Q 10/10; G06Q 30/0203

(57) ABSTRACT

Systems and methods are provided for use in conducting an assessment for a party. One exemplary computer-implemented method includes soliciting, by a framework computing device, at least one assessment response for a part of a framework, as defined by a guidance for a party and/or a business to which the party is associated, where the part of the framework relates to an area of the guidance, and receiving and storing, by the framework computing device, the at least one assessment response. The method also includes generating, by the framework computing device, a composite score for the framework for the party based, at least in part, on the at least one assessment response, and then presenting, by the framework computing device, the composite score to the user, thereby permitting the user to understand the performance of the party relative to the framework.

### CROSS-REFERENCE TO RELATED APPLICATION

This application claims the benefit of, and priority to, U.S. Provisional Application No. 62/950,484, filed on Dec. 19, 2019. The entire disclosure of the above-referenced application is incorporated herein by reference.

### FIELD

The present disclosure generally relates to systems and methods for providing assessment frameworks and, in particular, to systems and methods for use in conducting assessments of capabilities of different parties (e.g., conducting and reporting an assessment of a party based on guidance associated with a business of the party, etc.).

### BACKGROUND

This section provides background information related to the present disclosure which is not necessarily prior art.

It is known for governing bodies associated with and/or participants in a particular area and/or business to establish rules, certifications and control documents to govern or educate participants about standards and practices (e.g., best practices, etc.) in the area and/or business. One exemplary business includes account-to-account transfers, whereby standards and practices are provided by financial initiation participants of the business.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in conducting assessments of capabilities of different parties;

FIG. 2 illustrates an example framework that may be utilized in connection with conducting the assessments in the system of FIG. 1;

FIG. 3 illustrates a segment of the framework of FIG. 2;

FIGS. 4-19 illustrate example interfaces that may be displayed to parties in connection with conducting the assessments in the system of FIG. 1;

FIGS. 20-21 illustrate example scoring interfaces that may be displayed to parties in connection with conducting the assessments in the system of FIG. 1;

FIG. 22 is a block diagram of a computing device that may be used in the exemplary system of FIG. 1; and

FIG. 23 is a flow diagram of an exemplary method, which may be implemented in connection with the system of FIG. 1, for conducting and reporting an assessment of a party based on guidance associated with a business of the party (e.g., account-to-account payments, etc.).

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Standards, frameworks, certifications and control documents (broadly, guidance) are often associated with certain areas of business, and typically include criteria for the areas of business (e.g., services provided, etc.) in order to facilitate compliance of parties that participate in the particular areas. In connection therewith, the parties are tasked with investigating the different guidance, whereby each makes decisions about the party's compliance with the specific guidance, or not. In various embodiments, some details of the guidance, and its associated criteria, can make compliance difficult to achieve and/or document.

Uniquely, the systems and methods herein provide various tools to permit parties to assess their capabilities as they pertain to different guidance (e.g., relating to defensive and preventative security measures, responsive measures to disasters or attacks, etc.). In particular, guidance may include, in the context of account-to-account transfers, for example, hundreds of international ISO/IEC and financial standards, frameworks, certifications and control documents. Initially, the guidance for a particular business may be compiled into a set of control documents covering the guidance (e.g., as part of a control document matrix, data structure, etc.), and then a framework is compiled from the control documents (or directly from the guidance). Once compiled, the framework provides a tool for a party to assess compliance and/or capabilities relative to the guidance for the business. The framework is posed to a user associated with the party (i.e., a representative of the party) as a series of questions or queries, which permit the user to review the guidance (and any related control documents) and then answer and/or add artifact evidence of compliance (e.g., self-assessments, etc.) related thereto. The questions will often be presented in tiers (associated with the framework), where the tiers focus down into the details of the underlying guidance (e.g., through multiple parts, etc.). Based on the responses to the questions, the framework generates a score associated with each part and/or tier of the framework for the party. Based on the score, then, an overall or composite score (broadly, assessment) is generated for the party (e.g., via bottom-up scoring from the parts/tiers, etc.). Once the score is compiled, the framework generates a unique interface, which may define, for example, a bow-tie graphic, and which includes the composite score (and related assessment). The interface provides high-level insight into the performance of the party relative to the guidance, and permits a user to access the underlying scores (and responses, criteria, etc.), per tier and/or per part, to assess such performance.

In this manner, the framework described herein provides a repeatable methodology for assessing a party's compliance and/or capabilities relative to complex guidance for a business, industry or area. Additionally, the framework is also usable among different parties as a basis for comparison among the parties (e.g., by the parties, by regulators, etc.). In connection therewith, the framework is built on existing (and/or familiar) guidance for a given business, industry or area (rather than replacing and/or defining new guidance), thereby facilitating ease of integration, etc.

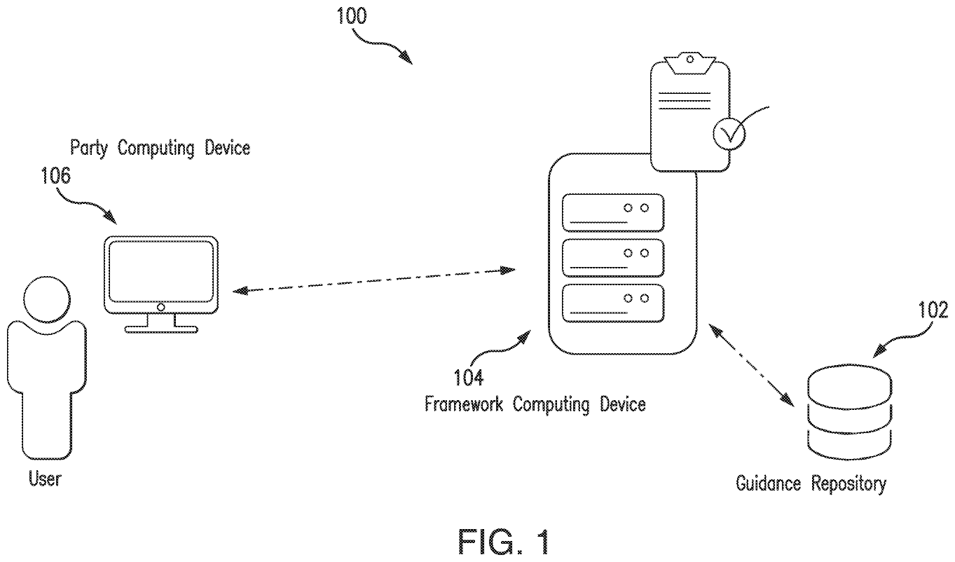

FIG. 1 illustrates an exemplary system 100 in which one or more aspects of the present disclosure may be implemented. Although the system 100 is presented in one arrangement, other embodiments may include the parts of the system 100 (or other parts) arranged otherwise depending on, for example, types of parties, types of interactions, types of businesses, types of guidance, privacy requirements, etc.

The system 100 generally includes a guidance repository 102, a framework computing device 104, and a party computing device 106, each of which is coupled to (and is in communication with) one or more networks. The network(s) is/are indicated generally by arrowed lines in FIG. 1, and may each include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

The guidance repository 102 includes, among other things, international standards, frameworks, certifications and/or control documents provided from the International Organization for Standards (or ISO) and/or the International Electrotechnical Commission (or IEC), or from one or more other suitable participants in setting and/or identifying standards or guidelines for parties and businesses (and, in particular, financial parties and related businesses or areas). It should be appreciated that the guidance repository 102 may include hundreds or more or less standards, frameworks, certifications and/or control documents related to a given topic. In this particular exemplary embodiment, the guidance repository 102 includes hundreds of standards, frameworks, certifications and/or control documents related to financial transfers (e.g., account-to-account payments, etc.). However, it should be appreciated that the present disclosure is not limited to financial businesses, whereby the guidance repository 102 may include standards, frameworks, certifications and/or control documents related to other technologies, businesses, etc.

Through various techniques, the guidance included in the guidance repository 102 is compiled into a set of control documents, and more specifically, a framework. The framework generally includes a hierarchical structure comprised of a series of multiple tiers, with each tier having multiple parts (e.g., guidance in the form of definitions, principles, objectives, outcomes, etc.). The parts are identified to one or more areas of the particular guidance from the guidance repository 102 (e.g., one part per area and/or criteria, etc.). The framework, once compiled, is stored in the framework computing device 104.

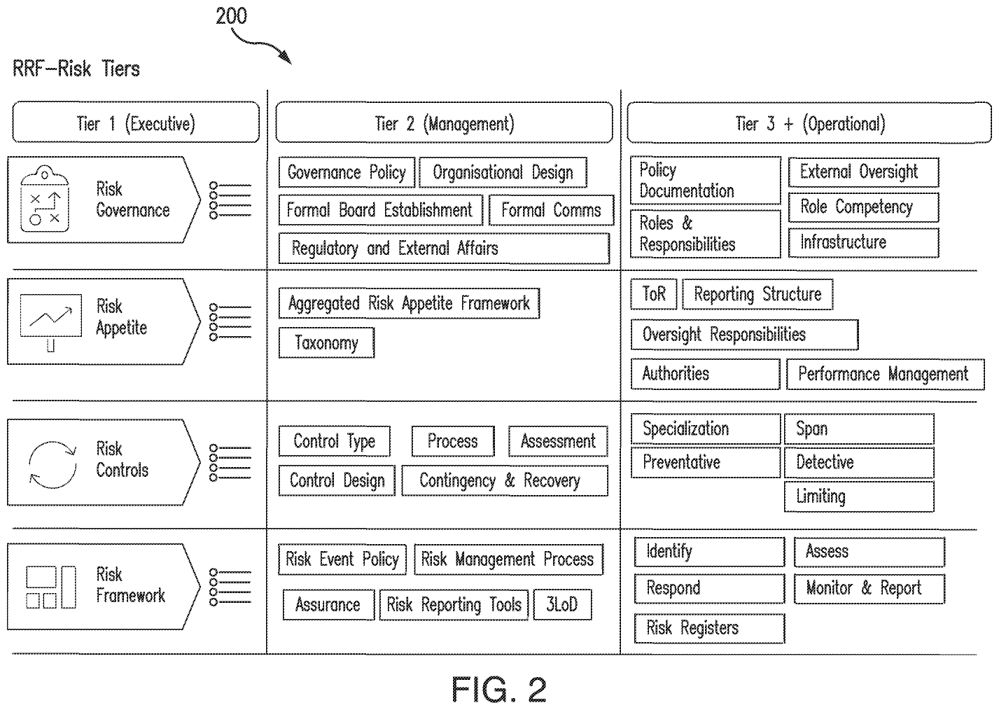

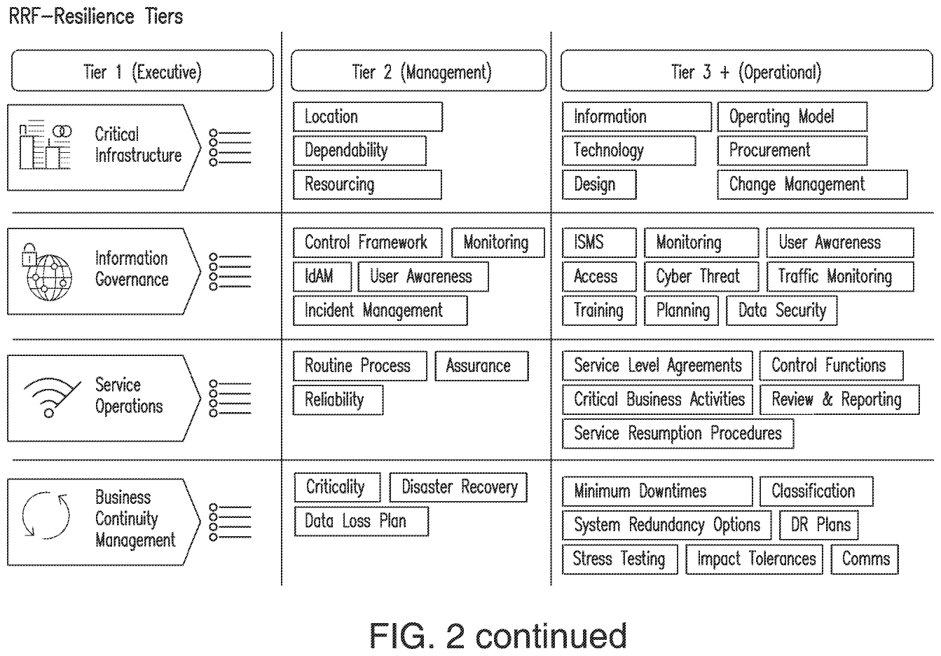

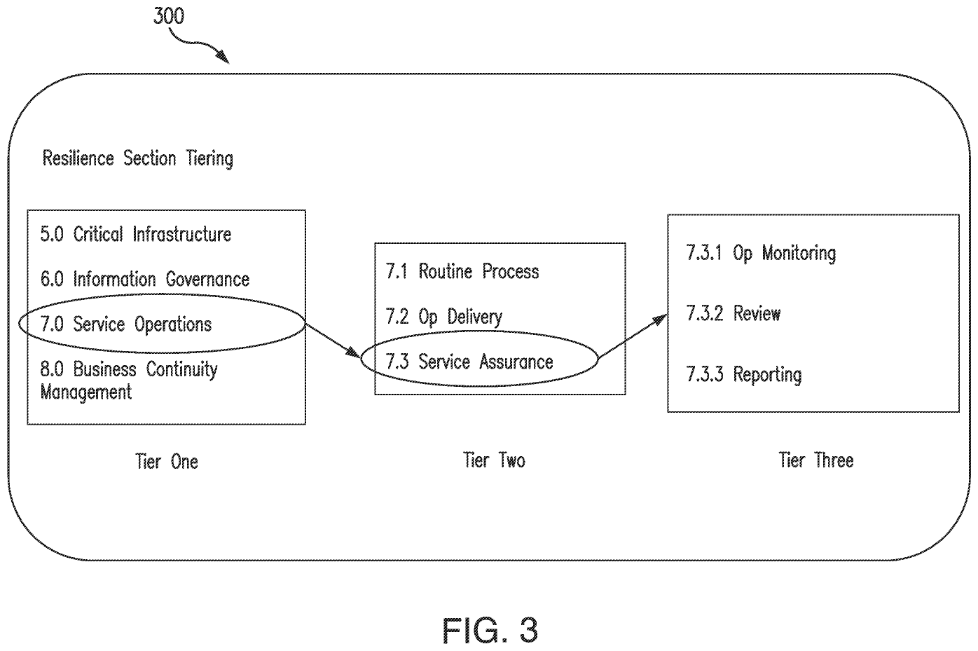

As an example, FIG. 2 illustrates an example framework 200 including eight parts at the tier one level (e.g., at an executive level, etc.). As shown, the example framework 200 includes 1.0 Risk Governance, 2.0 Risk appetite, 3.0 Risk Controls, 4.0 Risk Framework, 5.0 Critical Infrastructure, 6.0 Information Governance, 7.0 Service Operations, and 8.0 Business Continuity Management. The framework 200 then includes, for each tier one level, multiple parts at the tier two level (e.g., at a management level, etc.), and multiple parts at a tier three level (e.g., at an operational level, etc.). In connection therewith, FIG. 3 illustrates segment 300 of the example framework 200 (including resilience section tiering of the framework 200), and a selection of lower tiers for the 7.0 Service Operations part. As shown, for example, the 7.0 Service Operations part of the framework 200 includes the three tiers, with part 7.0 included in tier one, with parts (or sections) 7.1, 7.2 and 7.3 included in tier two, and with parts (or sub-sections) 7.3.1, 7.3.2, and 7.3.3 included in tier three. In general, the higher numbered tiers will include greater detail into the particular area associated with the part(s) and/or criteria thereof, and the lower numbered tiers will include less detail. The other parts of the framework 200, in this example, are similarly arranged. In such exemplary framework 200, the tiers enable review of the assessment, as described below, by users at different levels (e.g., executive versus management versus operations, etc.). That said, it should be appreciated that the framework 200 is exemplary in nature, and that other frameworks may include other parts and/or other numbers of parts, other tiers and/or numbers of tiers, and/or other arrangements in other embodiments.

It should be appreciated that the framework described herein (e.g., framework 200, etc.), in some embodiments, may be provided in two parts: a first part, which includes the guidance provided in four sections (e.g., governance, risk, resilience and enabling functions; etc.); and a second part, which includes the assessment tool (or self-assessment tool) in the form of an interactive questionnaire whereby the framework computing device 104 is permitted to generate scores to aid in measuring risk and resilience capability and maturity of a party with regard to the guidance in the first part.

What's more, it should be appreciated that the guidance from the guidance repository 102 may be compiled and/or organized into a variety of different frameworks, within the scope of the present disclosure.

In this exemplary embodiment, the framework computing device 104 is configured to interact with a user at a party to be assessed (and associated with the party computing device 106) (such as the user shown in FIG. 1), via a questionnaire, or otherwise, as part of the framework provided herein. The user may be an employee, manager, owner, regulator, etc., associated with the party. The framework computing device 104 is configured to interact with the user, then, via the party computing device 106. In connection therewith, once the user is authenticated (e.g., he/she is verified as an authorized user to act on behalf of the party (e.g., via a password, a biometric, etc.), etc.), the framework computing device 104 is configured to present core guidance data to the user (e.g., core control documents relating to a particular part of the framework and covering different compliance criteria (e.g., customer compliance, government compliance, governance, standards, regulatory compliance, policies, etc.), etc.) and solicit assessment inputs from the user relating thereto via one or more interfaces displayed at the party computing device 106 (for the entire framework). In general, the interface may take the form of a questionnaire, which solicits assessment responses, such as, for example, YES or NO responses to queries, ratings for one or more criteria (which is shown with the solicitation) (e.g., the party observes, partially observes, or does not observe a given criteria, etc.), artifacts or documents to be uploaded as evidence of compliance (e.g., policy documents, flow or process diagrams, etc.), and/or narrative or text explanations, etc. In connection with the solicitations, the interface may include links to the guidance repository 102, whereby the relevant criteria for the particular area of the guidance to which the solicitation pertains is displayed and/or accessible.

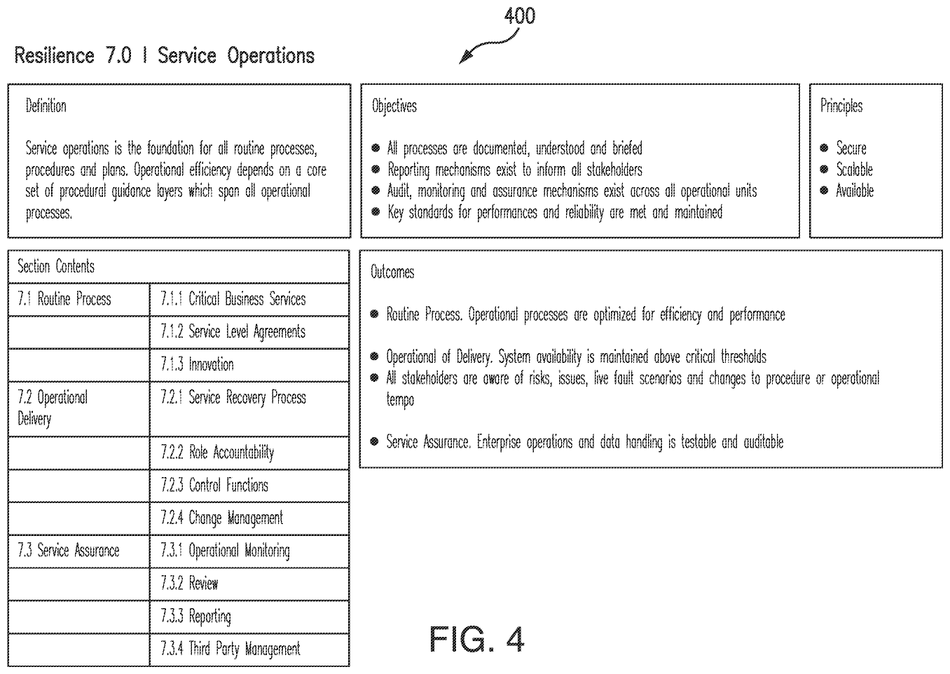

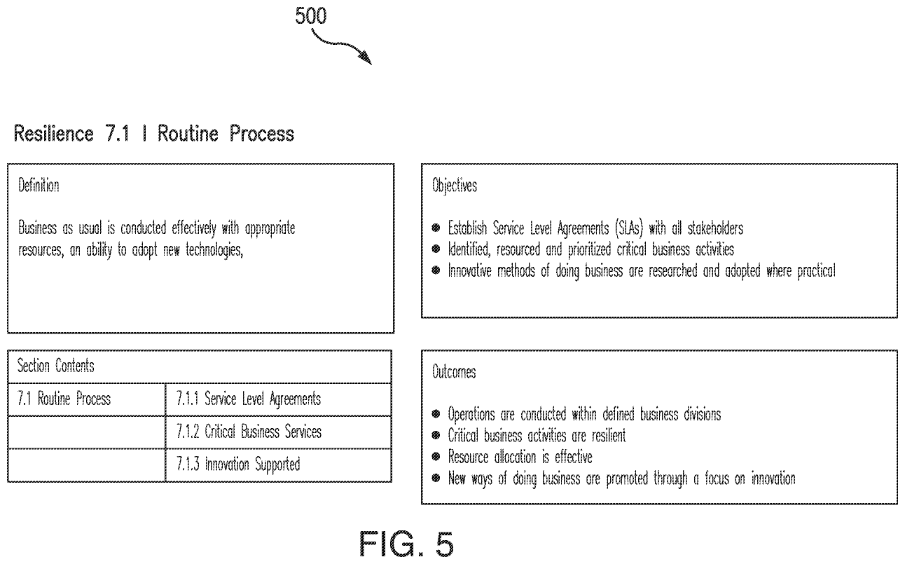

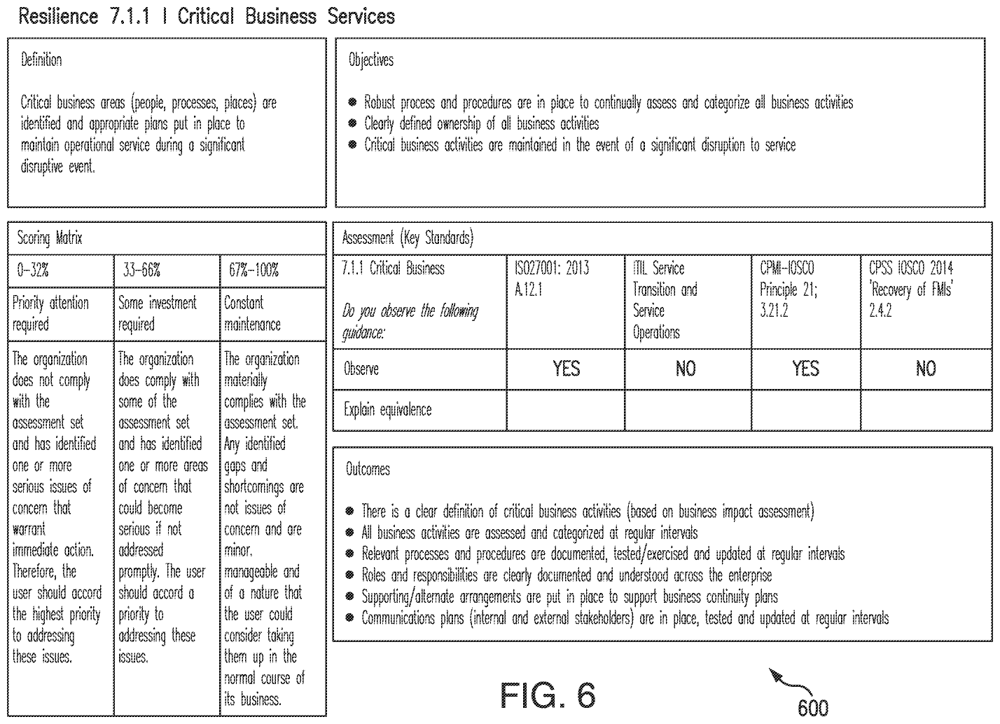

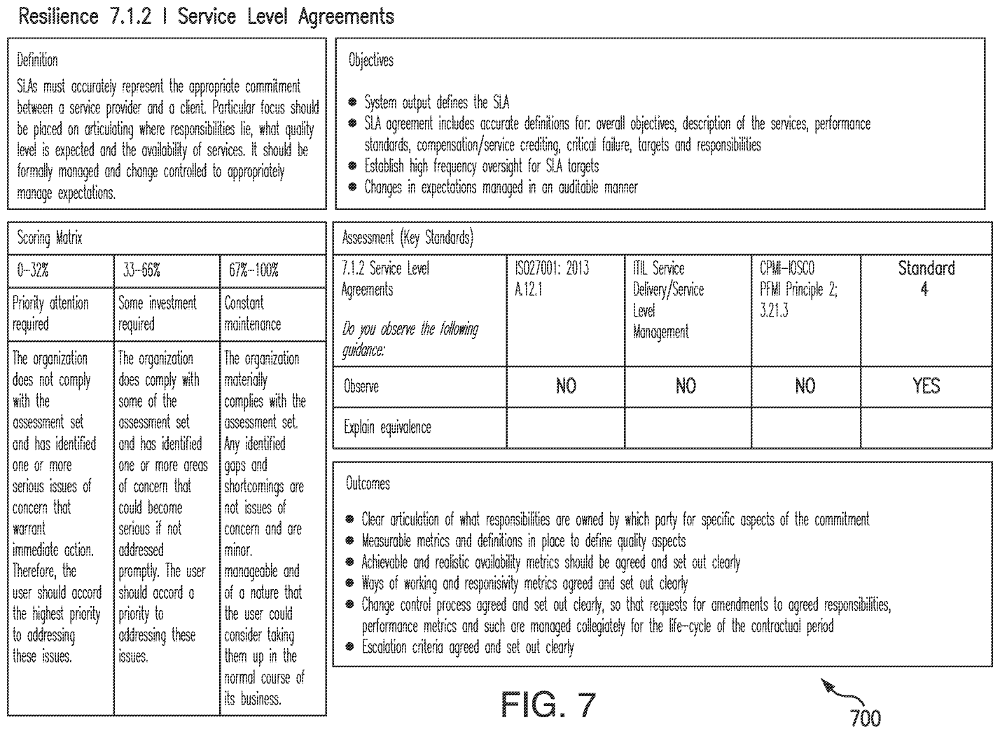

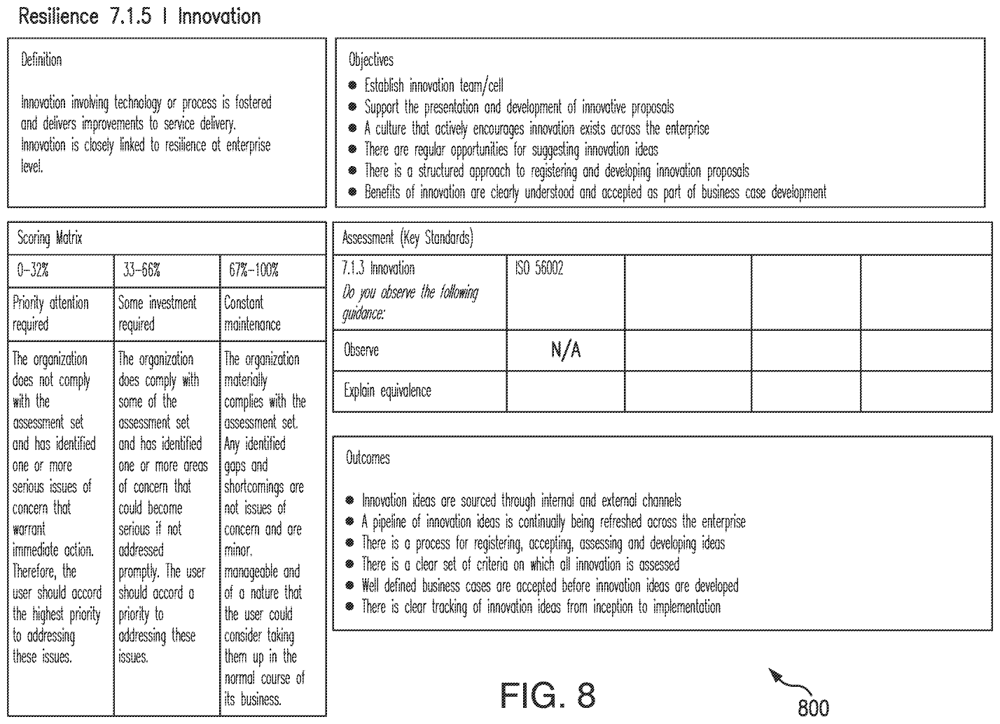

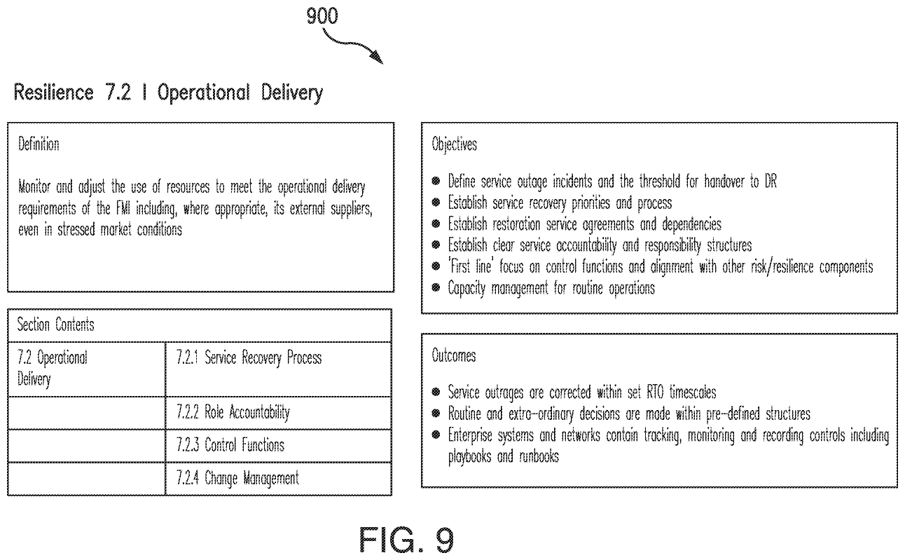

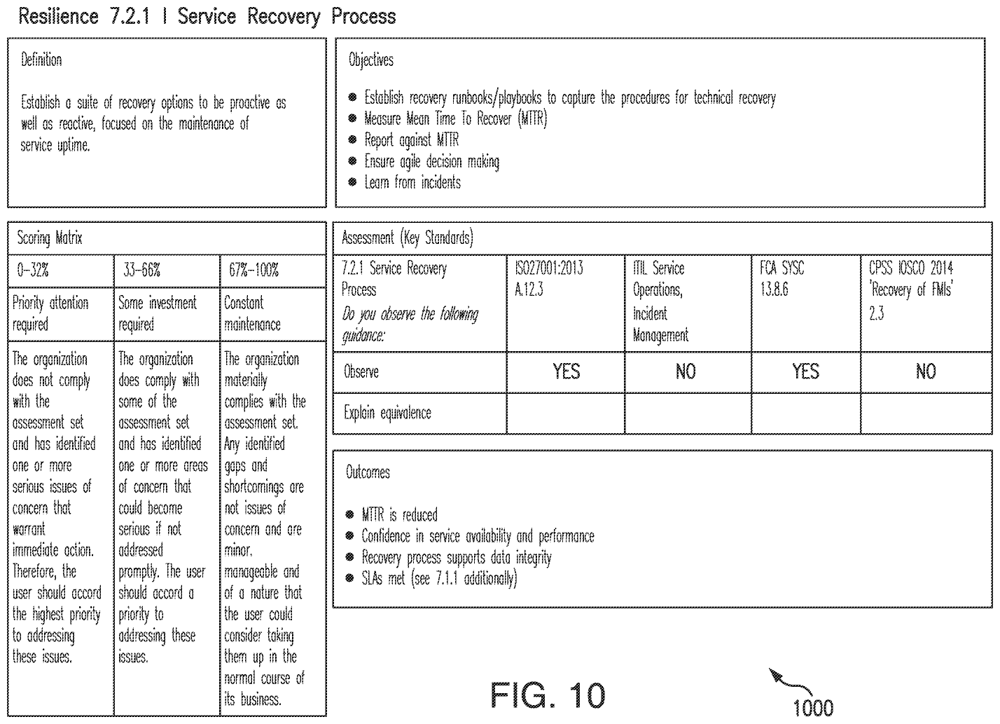

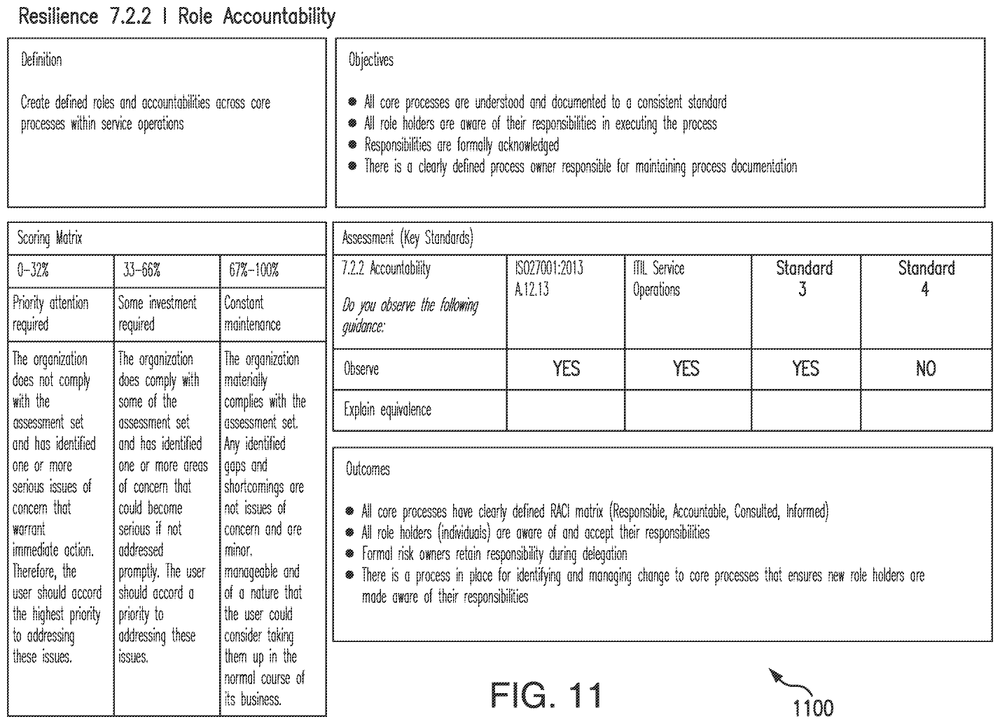

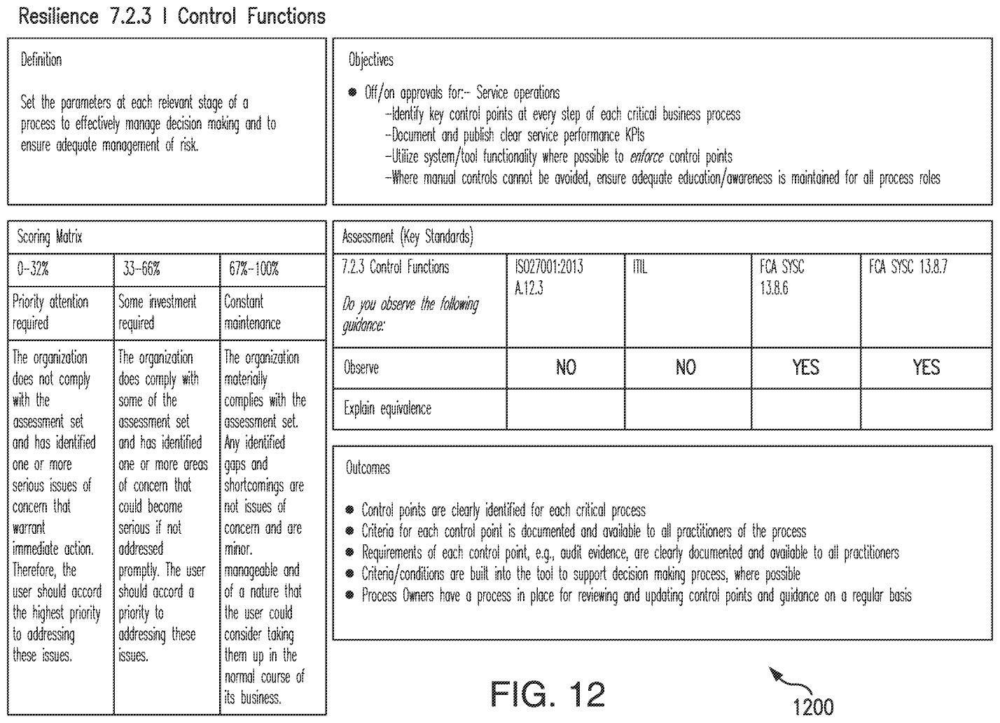

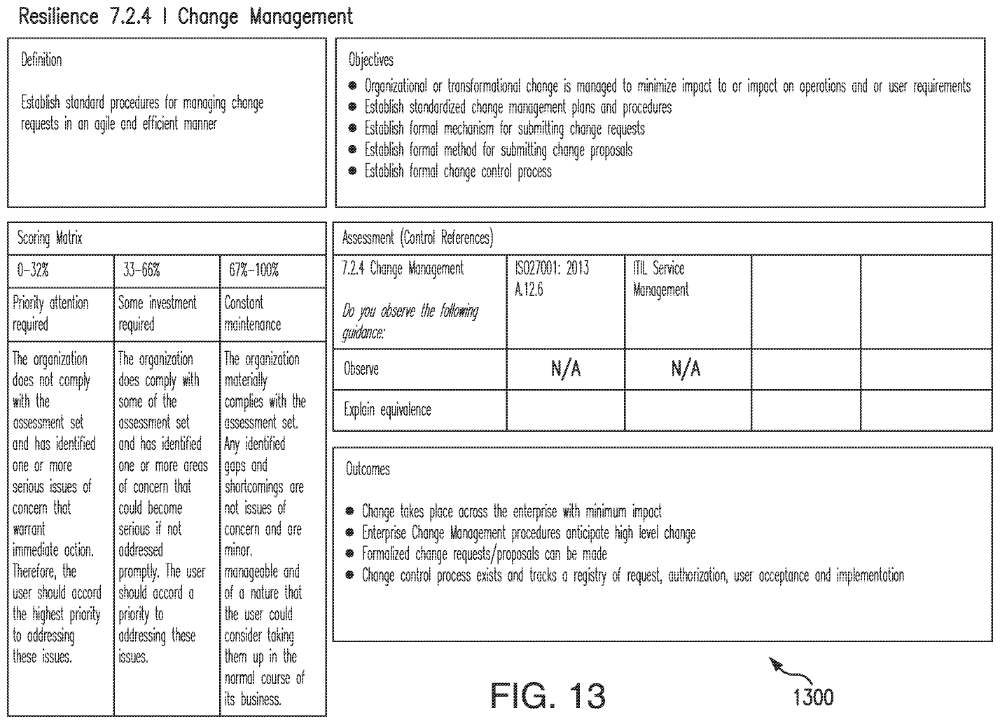

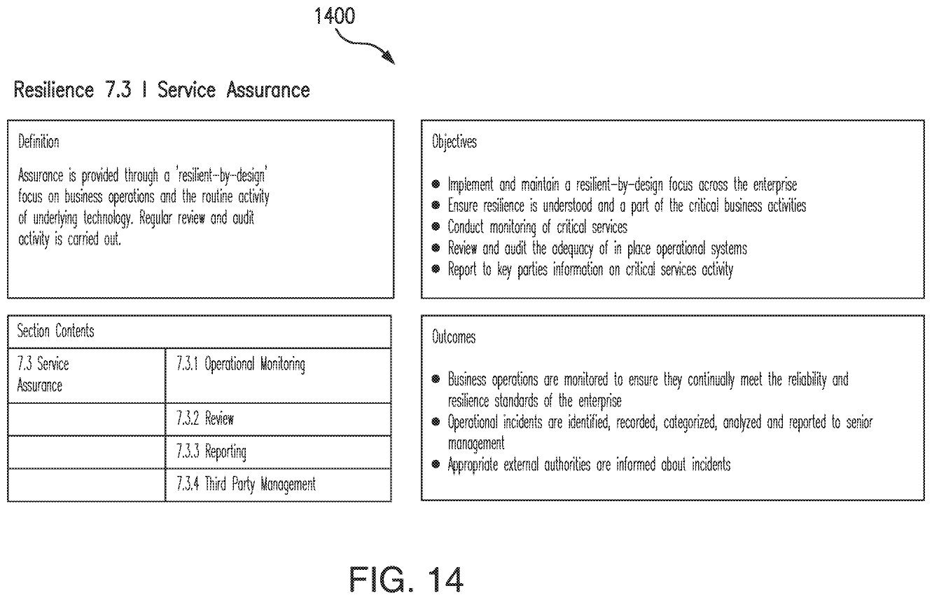

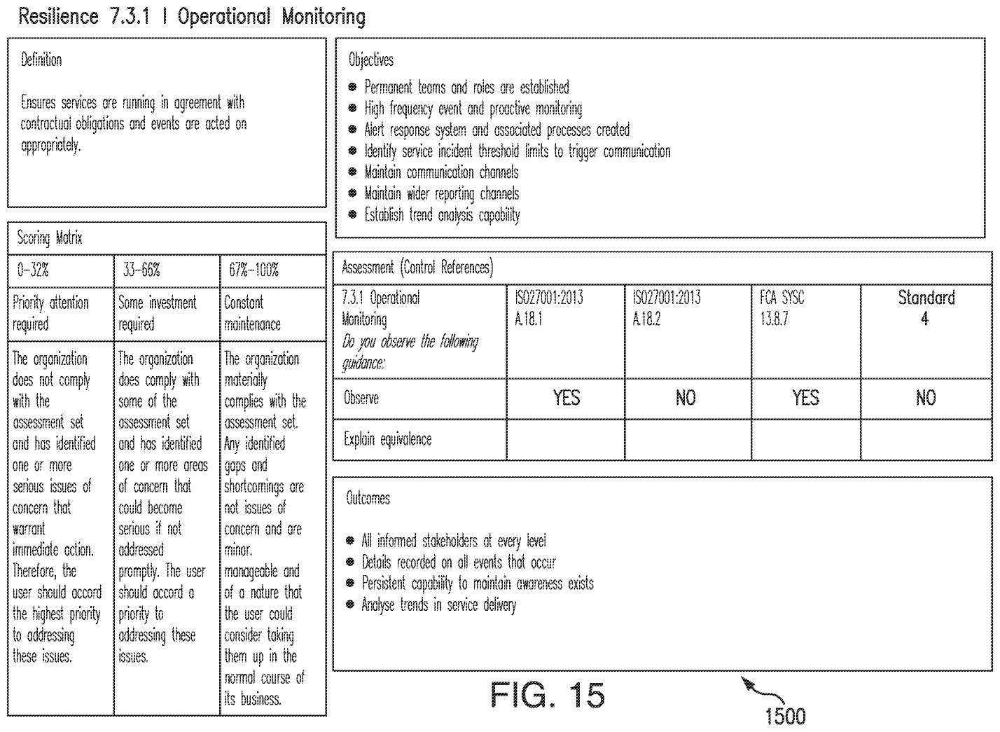

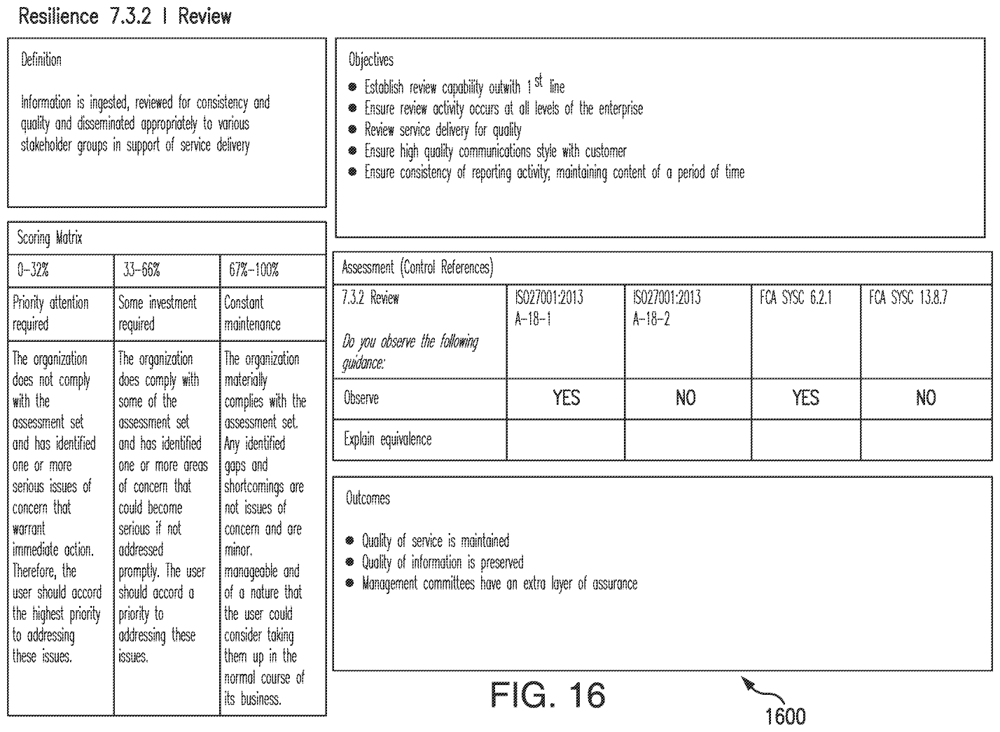

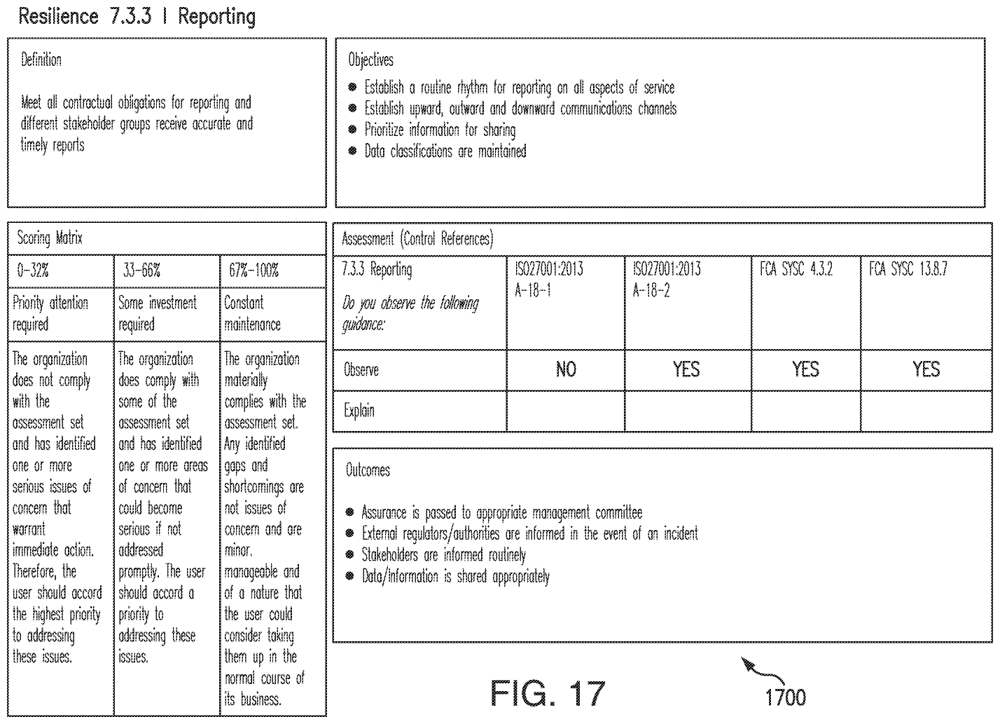

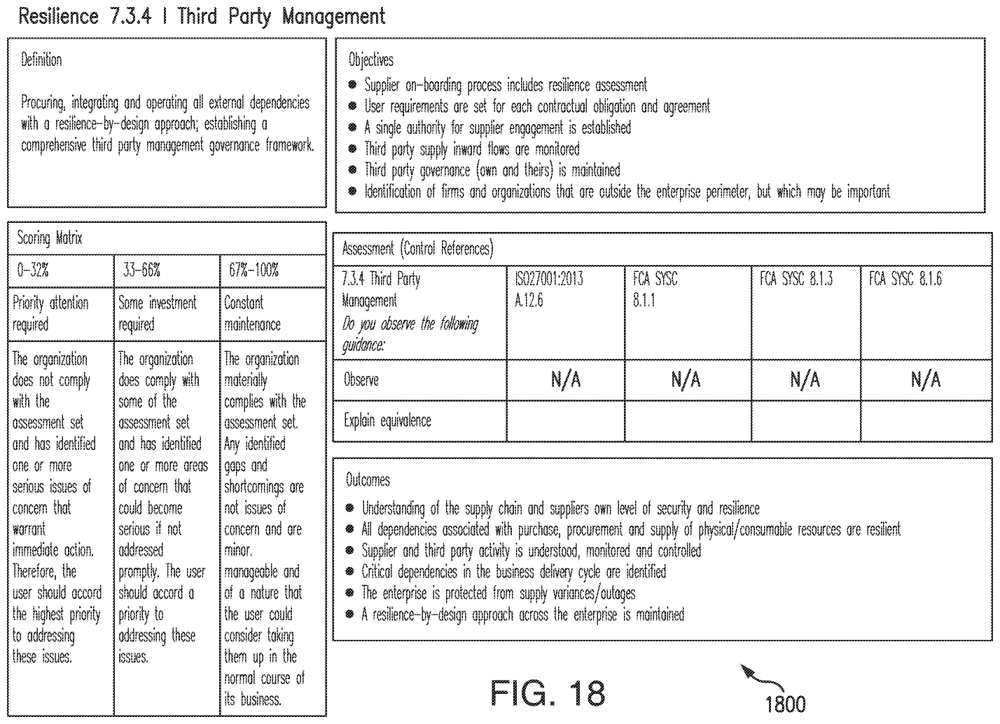

As an example, FIGS. 4-18 illustrate exemplary interfaces 400-1800 that may be presented to the user, at party computing device 106, in order to provide criteria to the user relating to self-assessment of the party, with regard to the 7.0 Service Operations part of the framework 200 (e.g., for segment 300 (FIG. 3) of framework 200 (FIG. 2), etc.), and in order to solicit corresponding responses from the user relating to the given criteria. In general, the interfaces 400-1800 provide a core guidance set of objectives, principles, and outcomes, along with a control document matrix (e.g., from the guidance repository 102, etc.), for evaluating different aspects of the party (at the given tiers for the overall hierarchy). For instance, the interface 400 provides an overview of the 7.0 Service Operations part of the framework 200 at tier one (including a definition, objections, principles, section contents, and outcomes). The interface 500 then provides an overview of the 7.1 Routine Process section (at tier two) of the 7.0 Service Operations part of the framework 200 (including a definition, objectives, second contents, and outcomes). And, interfaces 600-800 provide particular criteria for each tier three sub-section of the 7.1 Routine Process part (i.e., for 7.1.1 Critical Business Services, 7.1.2 Service Level Agreements, and 7.1.3 Innovation), as well as objectives therefor, a scoring matrix for the given sub-section, outcomes, and a solicitation of YES/NO responses as to whether the party observes the identified guidance for the sub-section. Interfaces 900-1800 illustrate similar details for each of the other sections (and sub-sections) of the 7.0 Service Operations part of the framework 200 (i.e., for 7.2 Operational Delivery and 7.3 Service Assurance).

In response, the user provides the assessment responses for the entire framework (e.g., via the interfaces 600-800, 1000-1300, and 1500-1800, etc. for the 7.0 Service Operations part of the framework 200; etc.), which may be understood to encompass a self-assessment of the party. When the responses are received, the framework computing device 104 is configured to generate a score for the party. In this exemplary embodiment, the assessment responses are YES and NO (e.g., as an indication of whether or not the party complies with, makes use of, or references the content in a given control document, etc.), whereby the framework computing device 104 is configured to record the YES/NO responses and tally the responses in the different tiers (and parts thereof) and then combine (e.g., sum, average, etc.) upward from tier three, for example, to tier two and then to tier one.

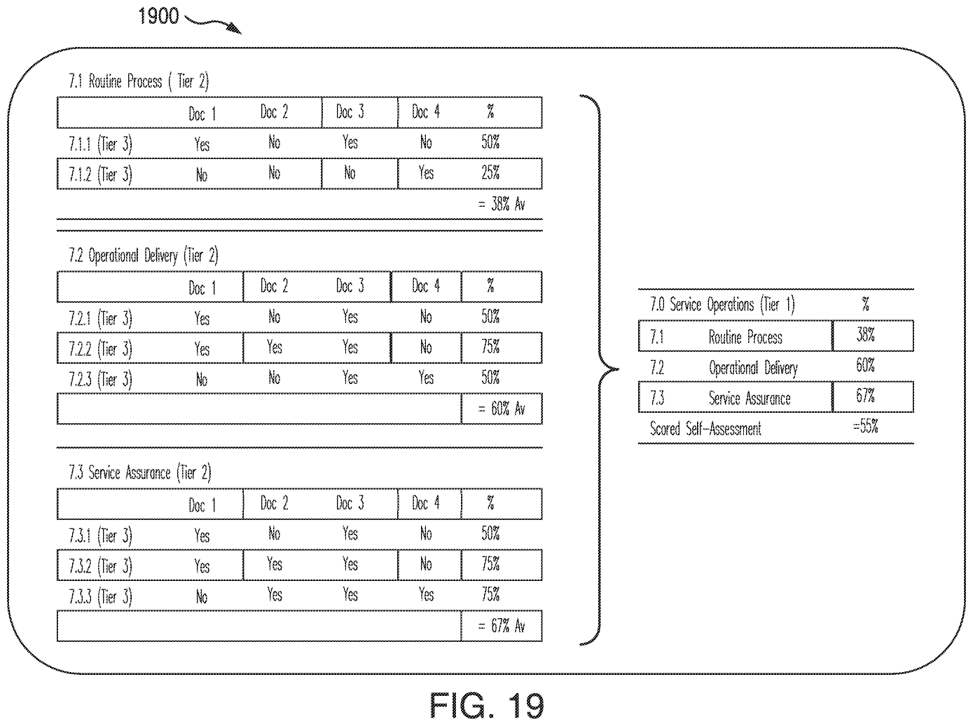

FIG. 19, for example, illustrates this scoring process, in interface 1900 (for the 7.0 Service Operations part of the framework 200), whereby the framework computing device 104 is configured to generate a score for the 7.0 Service Operations part of the framework 200 based on the YES responses to the interfaces 600-800, 1000-1300, and 1500-1800. As shown, the YES and NO responses for sub-section 7.1.1 of tier three provides a 50% score (i.e., for the four guidance documents/criteria included in the 7.1.1 Critical Business Services sub-section, relating to the 7.1 Routing Processing section, the user provides two YES responses and two NO responses). And, the YES and NO responses for sub-section 7.1.2 of tier three provides a score of 25% (i.e., for the four documents/criteria included in the 7.1.2 Service Level Agreements sub-section, relating to the 7.1 Routing Processing section, the user provides one YES response and three NO responses). No scores are provided for sub-section 7.1.3 of tier three in this example, as it may not be applicable to the given party. The score from sub-section 7.1.1 (50%) is then combined by the framework computing device 104 with the score from sub-section 7.1.2 (of 25%) to provide an average score of 38% for the 7.1 Routine Process section/tier of the framework 200. As further shown, the framework computing device 104 generates (in a similar manner) a score of 60% for the 7.2 Operational Delivery section/tier and a score of 67% for the 7.3 Service Assurance section/tier. The framework computing device 104 is then configured to average the scores from the three sections of the second tier, as shown, to provide an overall score of 55% for the 7.0 Service Operations part/tier of the framework 200. In this example, the framework computing device 104 is configured to average the scores across each of the second and third tiers to ultimately provide the score for the first tier. However, in other embodiments, the framework computing device 104 may instead be configured to sum the scores across each of the second and third tiers to provide the score for the first tier, or the framework computing device 104 may be configured to weight one or more of the scores for the second and/or third tier and then utilize the weighted score(s) in generating the score for the first tier (e.g., as a sum, as an average, etc.).

It should be appreciated that in this embodiment, the overall or composite score for the framework is based on all the tiers of the framework applicable to the party and/or the business to which the guidance is directed. As such, the framework computing device 104 combines scores from each of the parts and tiers of the framework to provide the overall or composite score (e.g., as an average of the scores for all of the individual parts, as a sum of the scores for all of the individual parts, etc.). In this way, the party is presented with an assessment of its existing measures as they pertain to the given framework (e.g., as they pertain to defensive and preventative actions, responsive actions to certain impacts on the party, etc.).

In some example embodiments, the composite score may be generated based on (or in association with) a weighting of importance (e.g., one or more predetermined values, etc.) applied to one or more of the parts and/or tiers. The weighting, then, may be used as a reference against which the given part, etc. is assessed in the delivery of the benchmarked assessment. For instance, if a given part of the framework is considered ‘critical’ for the given business/service at issue, it may be assigned a weighting of importance of 5 out of 5. When the party is then assessed in its ability to meet a set of requirements (e.g., an International Standard, etc.) with regard to the given part, the requirements are used to assess how much of the 5 out of 5 is meaningfully achieved. Where the full standard is not met (or satisfied), the part of the framework is awarded a lower corresponding score, such as 4 out of 5. By applying this approach across all parts assessed, the composite score can be achieved (e.g., as an average of the separate scores, as a sum of the separate scores, etc.). What's more, in some example embodiments, the scores may be generated for different businesses, services, etc. undertaken or performed by a party, and then further combined into an overall party score based on a weighting of importance for the given business, service, etc.

It should further be appreciated that the bottom up aggregation of the scores, based on the user's assessment response(s), is one of a number of ways to combine the different responses of the user and/or associated scores. It should also be appreciated that the different parts of a given tier, or tiers in general, may be weighted when combined to emphasize certain parts and/or tiers of the framework over others.

Thereafter, the framework computing device 104 is configured to display, present or otherwise deliver, the score to the user. In this exemplary embodiment, the framework computing device 104 is configured to display a score interface, which includes the score and presentations of the different parts and/or tiers of the framework (e.g., linked to the specific guidance in the guidance repository 102, or documents included therein, etc.). The scoring interface further permits the user to go back to the assessment and review responses, alter response, view artifacts, load artifacts, whereupon, in some instances, the framework computing device 104 is configured to re-generate or update the overall score for the part. In addition, the scoring interface may be accessible to other users associated with the party (in general, or at the direction of the user) (e.g., management, executives, leaders, compliance offers, etc.), or outside entities associated with review, regulation, etc., via the framework computing device 104.

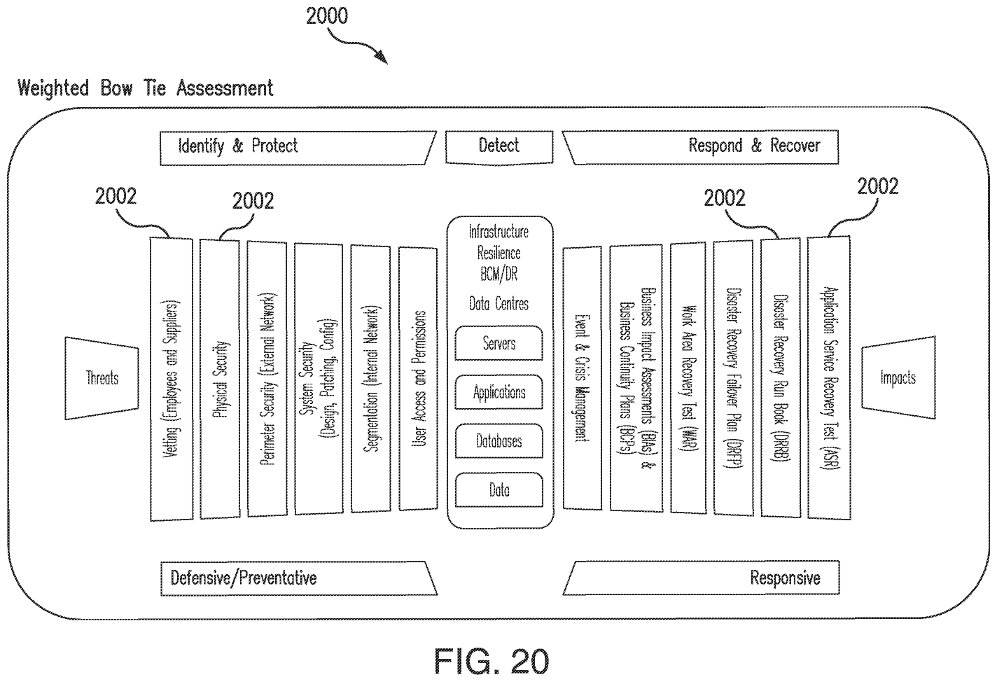

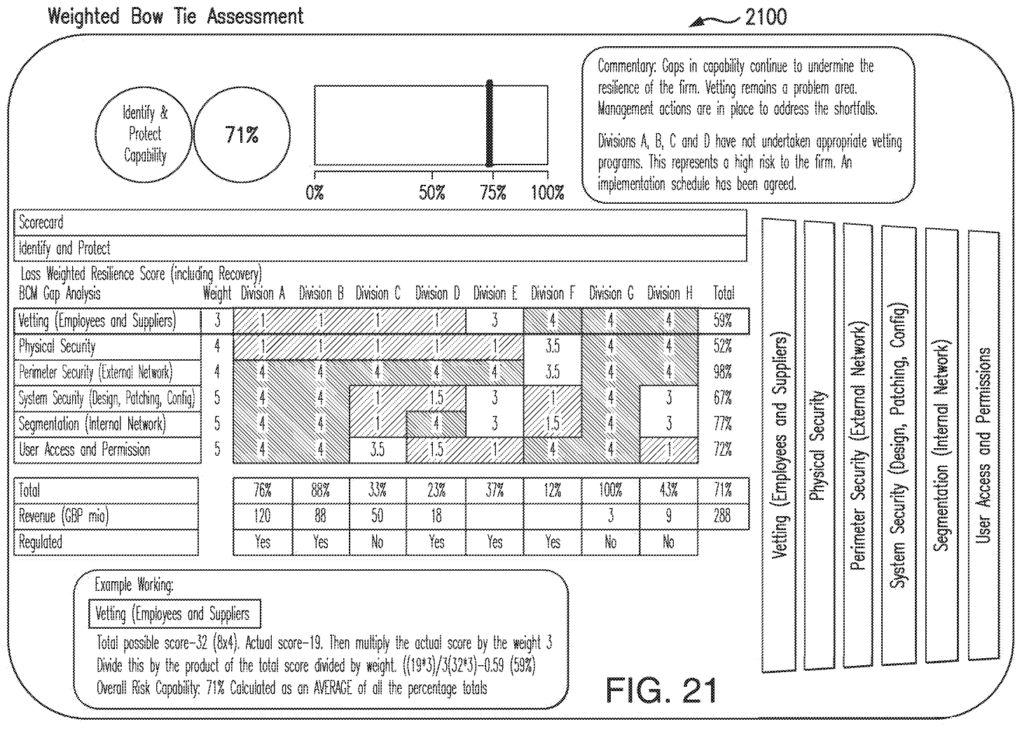

FIGS. 20 and 21 illustrate exemplary scoring interfaces 2000 and 2100 (e.g., scoring interfaces, etc.), based on a party's structure in place to deter certain threats and its response to the certain threats for a given framework. In the illustrated example, the interface 2000 provides a bow-tie graphic for the party's risk profile in which, visually, the user/party can review its assessment for the given framework (e.g., based on responses provided to the interfaces associated with the framework 200, etc.). In connection therewith, the interface 2000 includes multiple selectable portions/sections 2002 associated with the party's assessment, for example, vetting features, physical security features, perimeter security features, system security features, segmentation features, and user access and permission features with regard to identifying and protecting against the threats; infrastructure resilience features with regard to detecting the threats; and application service recovery features, disaster recovery features, work area recovery features, business impact and continuity features, and event and crisis management features with respect to response and recovery following the threats.

The interface 2100, then, includes a detailed assessment for the party for a selected one of the categories/features included in the selectable portion 2002 of the interface 2000. In particular in the interface 2100, the “Vetting” category/feature is selected (e.g., the interface 2100 is displayed to the user in response to selection of the “Vetting” section in the interface 2000, etc.). The interface 2100 generally includes a scoring and assessment section at the top (where the composite or overall score is shown for the party for the given framework relative to one or more thresholds (e.g., as the line at 71% relative to the various different color thresholds, etc.), for example), a scorecard section generally in the middle that displays details for the selected “Vetting” section together with details of the other sections associated with the party's responses to identifying and protecting against threats, and a description of the party's scoring as it specifically relates to the selected “Vetting” section. The interface 2100 then also includes the selectable sections for identifying and protecting against the threats toward the right (whereby the user can select other ones of the sections for review). Together, the scorecard section and the selectable section generally form a part of the bow-tie graphic in the interface 2100. That said, the threshold(s) included in the interface 2100 may be based on an input from the user (e.g., a self-imposed threshold, etc.), an average of composite scores from other parties (or like parties), a threshold imposed by the given business, etc.

As noted, the interface 2100 includes the example section toward the bottom to illustrate the generation of the score for the specific “Vetting” section. In use, the user may select a part of the framework on the right, whereupon the framework computing device 104 is configured to visually distinguish the score associated with that selected part (e.g., as shown by the box in the scoring interface, etc.). The user is then able to review the basis for the selected “Vetting” part of the framework. The user is permitted to select other parts of the framework (e.g., “Physical Security,” etc.), whereupon the framework computing device 104 is configured to virtually distinguish the related scoring. It should be appreciated that the user may further drilldown into a part of the framework, via the interface 2100, by double-clicking on (or otherwise selecting) the part, whereupon the framework computing device 104 is configured to display data from the next lowest tier in the same manner. The user retains, again, the ability to select particular parts of the framework and to drilldown again into a lower tier as desired.

In the illustrated interface 2100, each of the scoring categories included in the scorecard section is weighted, for instance, based on an importance thereof to the given business of the party being assessed, on a scale of one to five. For example, the “Vetting” category includes a weighting of three. The scorecard then also includes a score of one to four for each Division of the party, with regard to its compliance with one or more standards in the “Vetting” category. As shown, for the “Vetting” category, each of Divisions A-D has a score of 1, Division E has a score of 3, and each of Divisions F-H has a score of 4 (with corresponding color coding provided to visually illustrate the scores (e.g., a score of one to two is color coded with red to indicate additional work is required, a score of three is color coded with yellow to indicate some improvement may be required, and a score of four to five is color coded with green to indicate a satisfactory program, etc.). The Example Working section, as noted above, then provides details of the calculation for the total scoring for the “Vetting” category (i.e., to provide the total score of 59%).

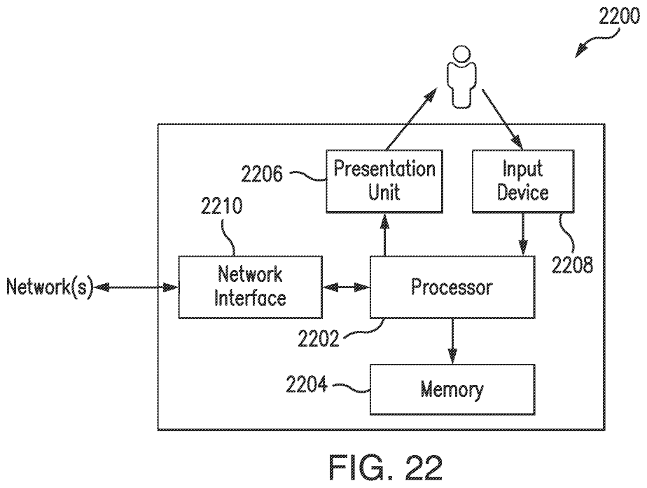

FIG. 22 illustrates an exemplary computing device 2200 that can be used in the system 100 of FIG. 1. The computing device 2200 may include, for example, one or more servers, workstations, personal computers, laptops, tablets, smartphones, etc. In addition, the computing device 2200 may include a single computing device, or it may include multiple computing devices located in close proximity or distributed over a geographic region, so long as the computing devices are specifically configured to function as described herein. In the exemplary embodiment of FIG. 1, the guidance repository 102, the framework computing device 104, and the party computing device 106 may each be included in (and/or may include) and/or may each be implemented in a computing device, consistent with and/or similar to the computing device 2200, coupled to (and in communication with) one or more networks. However, the system 100 should not be considered to be limited to the computing device 2200, as described below, as different computing devices and/or arrangements of computing devices may be used in other embodiments. In addition, different components and/or arrangements of components may be used in other computing devices.

Referring to FIG. 22, the exemplary computing device 2200 includes a processor 2202 and a memory 2204 coupled to (and in communication with) the processor 2202. The processor 2202 may include one or more processing units (e.g., in a multi-core configuration, etc.). For example, the processor 2202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 2204, as described herein, is one or more devices that permit data, instructions, etc., to be stored therein and retrieved therefrom. The memory 2204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 2204 may be configured to store, without limitation, international ISO/IEC and financial standards, other standards or guidance, frameworks, certifications and control documents, assessment responses, scores, interfaces, and/or other types of data (and/or data structures) suitable for use as described herein.

Furthermore, in various embodiments, computer-executable instructions may be stored in the memory 2204 for execution by the processor 2202 to cause the processor 2202 to perform one or more of the operations described herein (e.g., one or more of the operations described in method 2300, etc.), such that the memory 2204 is a physical, tangible, and non-transitory computer readable storage media. Such instructions often improve the efficiencies and/or performance of the processor 2202 and/or other computer system components configured to perform one or more of the various operations herein, whereby the instructions effectively transform the computing device 2200 into a special purpose device configured to perform the unique and specific operations described herein. It should be appreciated that the memory 2204 may include a variety of different memories, each implemented in one or more of the operations or processes described herein.

In the exemplary embodiment, the computing device 2200 also includes a presentation unit 2206 that is coupled to (and is in communication with) the processor 2202 (however, it should be appreciated that the computing device 2200 could include output devices other than the presentation unit 2206, etc.). The presentation unit 2206 outputs information (e.g., assessment scores, questions, etc.), visually or audibly, for example, to a user of the computing device 2200 (e.g., a user associated with a party being assessed, etc.), etc. And, various interfaces (e.g., as defined by one or more overall scores, insights, advice, etc.) may be displayed at computing device 2200, and in particular at presentation unit 2206, to display certain information to the user of the device. The presentation unit 2206 may include, without limitation, a liquid crystal display (LCD), a light-emitting diode (LED) display, an organic LED (OLED) display, an “electronic ink” display, speakers, etc. In some embodiments, presentation unit 2206 may include multiple devices.

In addition, the computing device 200 includes an input device 2208 that receives inputs from the user (i.e., user inputs) of the computing device 2200 such as, for example, assessment responses, etc., in response to assessment questionnaires/solicitations related to the framework, etc., as further described below. The input device 2208 may include a single input device or multiple input devices. The input device 2208 is coupled to (and is in communication with) the processor 2202 and may include, for example, one or more of a keyboard, a pointing device, a mouse, a camera, a touch sensitive panel (e.g., a touch pad or a touch screen, etc.), another computing device, and/or an audio input device. In various exemplary embodiments, a touch screen, such as that included in a tablet, a smartphone, or similar device, may behave as both the presentation unit 2206 and an input device 2208.

Further, the illustrated computing device 2200 also includes a network interface 2210 coupled to (and in communication with) the processor 2202 and the memory 2204. The network interface 2210 may include, without limitation, a wired network adapter, a wireless network adapter, or other device capable of communicating to one or more different ones of the networks herein and/or with other devices described herein. In some exemplary embodiments, the computing device 2200 may include at least one processor (e.g., the processor 2202, etc.), at least one memory (e.g., the memory 2204, etc.), and/or one or more network interfaces (e.g., network interface 2210, etc.) included in, or incorporated into or with the at least one processor.

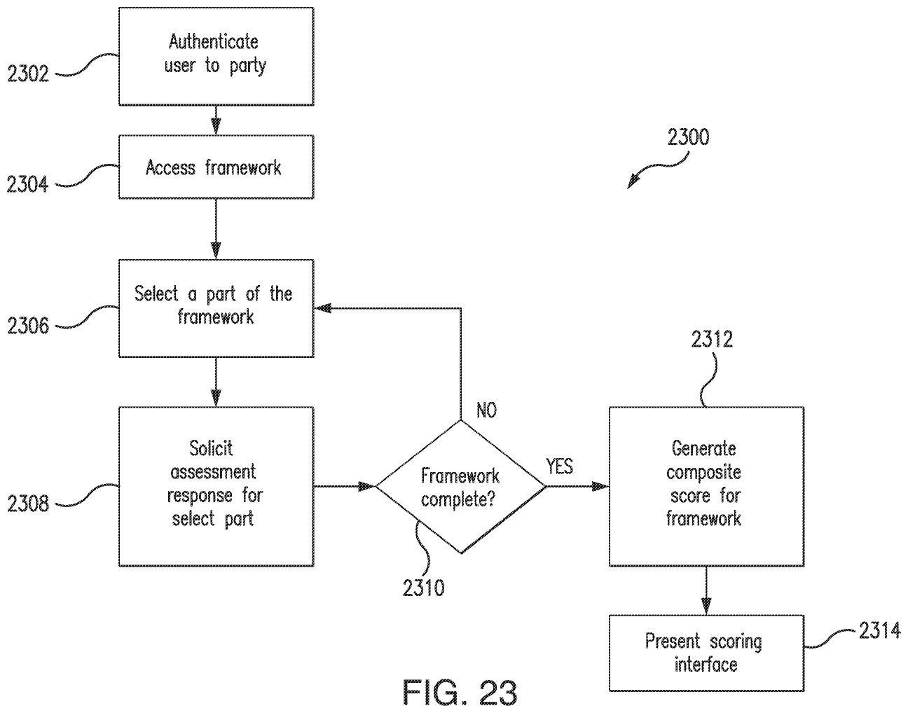

FIG. 23 illustrates an exemplary method 2300 for use in conducting and reporting an assessment of a party based on guidance associated with a business of the party. The exemplary method 2300 is described as implemented in the system 100, and with further reference to the computing device 2200. However, the methods herein should not be understood to be limited to the system 100 or the computing device 2200, as the methods may be implemented in other systems and/or computing devices. Likewise, the systems and the computing devices herein should not be understood to be limited to the exemplary method 2300.

In the method 2300, when desired to conduct an assessment of the party based on guidance associated with a business of the party, the user accesses the framework, at the framework computing device 104, via the party computing device 106. In connection therewith, the framework computing device 104 authenticates, at 2302, the user based on a password, biometric, etc., known or in possession of the user (and which the framework computing device 104 has a reference for comparison).

Once authenticated, the framework computing device 104 accesses, at 2304, a framework specific to the user and/or the party with which the user is associated and/or the business to which the party relates. The framework computing device 104 then identifies a part of the framework, at 2306, and solicits, at 2308, an assessment response from the user for the part of the framework. The solicitation may be in the form of one or more questionnaire interfaces, such as illustrated in FIGS. 3-17 (and discussed above in the system 100), displayed to the user at the party computing device 106. The questionnaire interface(s) may include a title of the part of the framework (along with a reference number (e.g., 7.0, 7.1, 7.1.1, etc.)), a definition of the part, a description of the objective of the part, a scoring description, the specific guidance and/or criteria involved in the part, etc. It should be appreciated that the questionnaire interface(s) may further solicit the response and/or an artifact associated with the response. In turn, the user will provide the assessment response (e.g., YES/NO response, Always/Sometimes/Never response, artifact(s) uploads/attachments, etc.).

In turn, the framework computing device 104 determines, at 2310, whether the framework is complete (i.e., an assessment response has been solicited for each part (e.g., including each tier, etc.) of the framework). When not completed, the framework computing device 104 returns to 2306 to select a next or different part of the framework, and continues to solicit assessment responses for each desired (or required) part. When complete, the framework computing device 104 generates, at 2312, a composite or overall score for the party based on the assessment responses from the user. As described above, in this embodiment, the composite score is generated by combining scores/responses at one tier (e.g., a highest number tier, a most detailed tier, etc.) to/with another tier (e.g., to a lower number tier, less detailed tier, etc.). The score may be combined by averaging or summing the scores from the different parts of the framework, or otherwise (as described herein).

When the composite score is generated, the framework computing device 104 includes the composite score, including the scores and/or details of the assessment responses, into a scoring interface, which is presented, at 2314, to the user at the party computing device 106. The details of the scoring interface are explained above and, again, are illustrated in the example interface 1900 of FIG. 19.

It should be appreciated that the method 2300 may be updated to include new and/or different assessment responses, whereby steps 2312 and 2314 may be repeated to reflect the new and/or different and/or updated responses.

In view of the above, the systems and methods herein provide for (and/or implement) a risk and resilience framework for use in assessing capabilities of parties in particular businesses, industries, etc., as they pertain to different guidance relating to such businesses, industries, etc. In particular, through the framework, users associated with the parties can self-assess governance, risk and resilience capabilities of the parties in the particular businesses, industries, etc. of interest, based on standards, control documents, etc. associated therewith. In addition, common benchmarks may be used for the businesses, industries, etc., whereby different parties in the same or similar businesses, industries, etc. are reviewed against the same metrics and methodologies. The users are then provided a dashboard assessment identifying and prioritizing portions of the parties business, etc. requiring improvement, with regard to the standards, control documents, etc., and providing comparison against peer parties. What's more, the framework may be repeated by the parties to monitor improvements, etc.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated, again, that one or more aspects of the present disclosure transform a general-purpose computing device into a special-purpose computing device when configured to perform the particular functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations (a) soliciting at least one assessment response for a part of a framework, as defined by a guidance for a party and/or a business to which the party is associated, the part of the framework related to an area of the guidance; (b) receiving and storing the at least one assessment response; (c) generating a composite score for the framework for the party based, at least in part, on the at least one assessment response; (d) presenting the composite score to the user, thereby permitting the user to understand the performance of the party relative to the framework; (e) generating a scoring interface for display to the user, wherein the scoring interface includes the composite score; (f) displaying a criteria associated with the area of the guidance to the user; (g) receiving and storing an artifact associated with the at least one assessment response; (h) and presenting a score for a part of the graphic representation, which makes up the composite score, in response to a selection of the part of the graphic representation.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in conducting an assessment for a party, the method comprising:
soliciting, by a framework computing device, at least one assessment response for a part of a framework, as defined by a guidance for a party and/or a business to which the party is associated, the part of the framework related to an area of the guidance;
receiving and storing, by the framework computing device, the at least one assessment response;
generating, by the framework computing device, a composite score for the framework for the party based, at least in part, on the at least one assessment response; and
presenting, by the framework computing device, the composite score to the user, thereby permitting the user to understand the performance of the party relative to the framework.

2. The computer-implemented method of claim 1, wherein soliciting the at least one assessment response includes displaying a criteria associated with the area of the guidance to the user.

3. The computer-implemented method of claim 1, wherein receiving the at least one assessment response includes receiving and storing an artifact associated with the at least one assessment response.

4. The computer-implemented method of claim 1, wherein the part is included in a tier of the framework, and wherein the at least one assessment response is specific to the part and the tier of the framework; and
wherein generating the composite score includes combining the at least one assessment response with at least one other assessment response specific to a different part of said tier of the framework.

5. The computer-implemented method of claim 1, wherein the framework includes multiple tiers, one of the multiple tiers including said part of the framework; and
wherein generating the composite score includes combining scores for a higher one of the multiple tiers into a score for a lower one of the multiple tiers.

6. The computer-implemented method of claim 1, wherein presenting the composite score includes presenting the composite score as part of a scoring interface, the scoring interface including a graphic representation of the framework.

7. The computer-implemented method of claim 6, further comprising presenting a score for a part of the graphic representation, which makes up the composite score, in response to a selection of the part of the graphic representation.

8. The computer-implemented method of claim 6, wherein the scoring interface further includes the composite score relative to a threshold; and
wherein the threshold is based on one of an input from the user and an average of composite scores from other parties associated with the business to which the party is related.

9. The computer-implemented method of claim 6, wherein the framework includes multiple parts, whereby the graphic representation includes the multiple parts.

10. A system for use in conducting an assessment for a party, the system comprising a framework computing device configured to:
generate an assessment interface for a part of a guidance framework for assessing a party, the assessment interface including at least one assessment for the part of the guidance framework based on at least one standard relating to a business to which the party is associated;
solicit, through the assessment interface, a response to the at least one assessment by the party;
receive, through the assessment interface, the response to the at least one assessment by the party and store the response in memory associated with the guidance framework computing device;
compile a composite score for the party, for the guidance framework, based, at least in part, on the response by the party to the at least one assessment;
generate a scoring interface for the guidance framework, the scoring interface including the composite score for the party; and
present the scoring interface to a user associated with the party, thereby permitting the user to understand the performance of the party relative to the guidance framework.

11. The system of claim 10, wherein the scoring interface further includes the composite score relative to a threshold; and
wherein the threshold is based on one of an input from the user and an average of composite scores from other parties associated with the business to which the party is related.

12. The system of claim 11, wherein the scoring interface includes a graphic representation of the guidance framework.

13. The system of claim 12, wherein the framework computing device is further configured to present, via the scoring interface, a score for the part of the guidance framework, as part of the composite score, in response to a selection of the part in the graphic representation of the guidance framework at the scoring interface.

14. The system of claim 13, wherein the guidance framework includes multiple parts, and wherein the graphic representation of the guidance framework includes the multiple parts.

15. The system of claim 10, wherein the score interface includes a scorecard section including the composite score and a selectable section, the scorecard section and the selectable section forming a bow-tie graphic.

16. A non-transitory computer-readable storage medium including executable instructions for use in conducting an assessment for a party, which when executed by at least one processor, cause the at least one processor to:
solicit at least one assessment response for a part of a framework, as defined by a guidance for a party and/or a business to which the party is associated, the part of the framework related to an area of the guidance;
receive the at least one assessment response via at least one interface;
store the at least one assessment response in memory in communication with the at least one processor;
generate a composite score for the framework for the party based, at least in part, on the at least one assessment response; and
present the composite score to the user, thereby permitting the user to understand the performance of the party relative to the framework.

17. The non-transitory computer-readable storage medium of claim 16, wherein the at least one processor is configured, in order to solicit the at least one assessment response, to display a criteria associated with the area of the guidance to the user.

18. The non-transitory computer-readable storage medium of claim 17, wherein the part is included in a tier of the framework, and wherein the at least one assessment response is specific to the part and the tier of the framework; and
wherein the at least one processor is configured, in order to generate the composite score, to combine the at least one assessment response with at least one other assessment response specific to a different part of said tier of the framework.

19. The non-transitory computer-readable storage medium of claim 18, wherein the framework includes multiple tiers, one of the multiple tiers including said part of the framework; and
wherein the at least one processor is configured, in order to generate the composite score, to further combine scores for a higher one of the multiple tiers into a score for a lower one of the multiple tiers.

20. The non-transitory computer-readable storage medium of claim 19, wherein the at least one processor is configured, in order to present the composite score includes, to generate a scoring interface including the composite score;
wherein the scoring interface further includes a graphic representation of the multiple tiers of the framework.
